(19) United States
(12) Patent Application Publication
(10) Pub. No.: US 2021/0165240 A1
(43) Pub. Date: Jun. 3, 2021

(54) Optical Member Driving Device, Camera Device and Electronic Apparatus

(71) Applicant: New Shicoh Motor Co. Ltd., Zhejiang (CN)

(72) Inventors: Wei HUA, Zhejiang (CN); Cai ZHENPENG, Zhejiang (CN)

(21) Appl. No.: 17/104,690

(22) Filed: Nov. 25, 2020

(30) Foreign Application Priority Data
Nov. 28, 2019 (CN) 201922087122.X

(51) Int. Cl. G02B 27/64; G03B 5/00

(52) U.S. Cl. CPC G02B 27/646; G03B 2205/0007; G03B 5/00

(57) ABSTRACT

An optical member supporting device is described that includes a carrier provided with a through hole for mounting an optical member and having a rectangular shape, a housing having two opposite plates sandwiching the carrier and a plurality of column portions rising from one plate of the two plates toward the other plate of the two plates, and springs arranged between the carrier and the housing. Chamfered corner surfaces are provided at four corners of the carrier, and viscoelastic resin is provided between the corner surfaces and opposite surfaces of the column portions facing the corner surfaces.

### CROSS-REFERENCE TO RELATED APPLICATION

This application claims the benefit of Chinese Utility Model application CN 201922087122.X, filed on Nov. 28, 2019, the contents of which are incorporated by reference herein.

### TECHNICAL FIELD

The present disclosure relates to an optical member driving device used in electronic apparatus such as smartphones, a camera device, and an electronic apparatus.

### BACKGROUND

There is a Patent Document of Chinese utility model CN209044147U (hereinafter referred to as “Patent Document 1”) which discloses a technique related to camera devices installed in electronic apparatus such as smartphones. The vibration suppression structure for voice coil motor according to Patent Document 1 has a carrier for holding a lens, and a base to support the carrier. In this vibration suppression structure, coating expansion portions projecting outward are formed at the four corners of the carrier, and viscoelastic resin is provided between the coating expansion portions and the columns rising from the four corners of the base. The viscoelastic resin provides a vibration suppression effect when the carrier is driven.

However, in case of the technique in Patent Document 1, there is a problem that it is necessary to make the carrier into a shape with coating expansion portions at four corners, so that the processing of the carrier takes time.

### SUMMARY

In view of such problem, an object of the present disclosure is to provide an optical member driving device, a camera device and an electronic apparatus, which can exhibit stable vibration suppression effect and are easily manufactured.

In order to solve the above problem, according to a first aspect of the present disclosure, there is provided an optical member supporting device including: a carrier provided with a through hole for mounting an optical member and having a rectangular shape; a housing having two opposite plates sandwiching the carrier and a plurality of column portions rising from one plate of the two plates toward the other plate of the two plates; and springs arranged between the carrier and the housing. Chamfered corner surfaces are provided at four corners of the carrier, and viscoelastic resin is provided between the corner surfaces and opposite surfaces of the column portions facing the corner surfaces.

According to a second aspect of the present disclosure, there is provided a camera device including the optical member supporting device described above.

According to a third aspect of the present disclosure, there is provided an electronic apparatus including the camera device described above.

### BRIEF DESCRIPTION OF DRAWINGS

FIG. 1 is a front view of a smartphone mounted with a camera device including an optical member driving device according to an embodiment of the present invention;

FIG. 2 is a perspective view of the optical member driving device shown in FIG. 1;

FIG. 3 is an exploded perspective view of the optical member driving device shown in FIG. 2;

FIG. 4 is an exploded perspective view of the optical member driving device shown in FIG. 2;

FIG. 5 is a diagram showing a configuration in a case of the optical member driving device shown in FIG. 2;

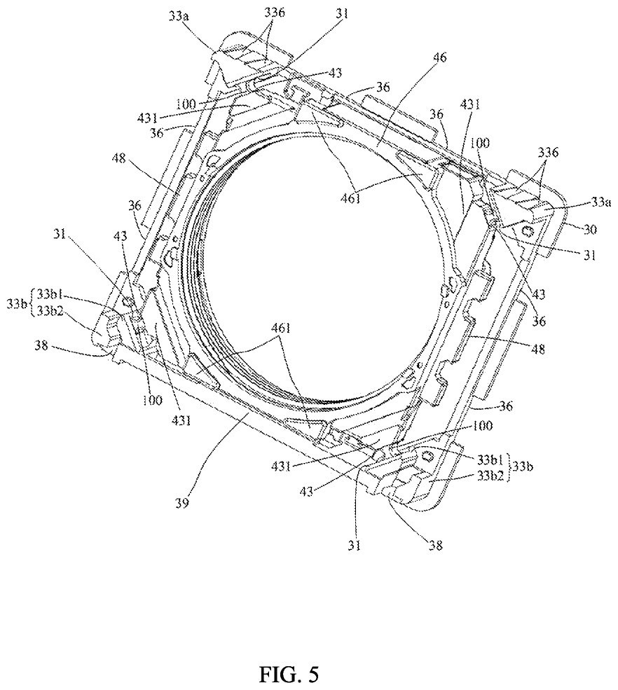

FIG. 6 is a diagram showing a portion in which viscoelastic resin is arranged in the optical member driving device of FIG. 2; and

FIG. 7 is a diagram showing a portion in which the viscoelastic resin is arranged in the optical member driving device of FIG. 2.

### DETAILED DESCRIPTION

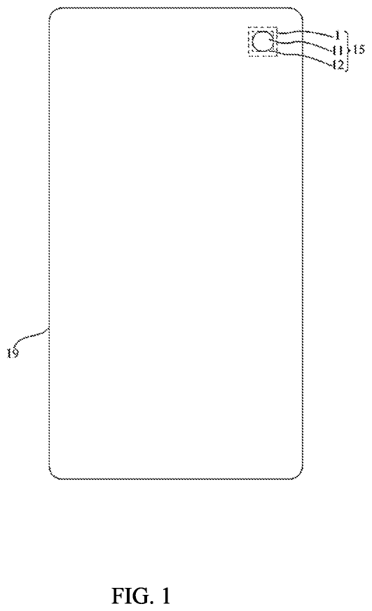

Hereinafter, embodiments of the present invention are explained with reference to drawings. As shown in FIG. 1, a camera device 15 including an optical member driving device 1 according to one embodiment of the present invention is embedded in a housing of a smartphone 19.

The camera device 15 includes: a lens body 11 which is an optical member; an image sensor 12 to convert light incident via the lens body 11 into an image signal; and an optical member driving device 1 to drive a lens body 11 while holding the lens body 11 and the image sensor 12. Hereinafter, an optical axis direction of lens body 11 is appropriately referred to as a Z-direction, one direction orthogonal to the Z direction is appropriately referred to as an X-direction, and a direction orthogonal to both the Z-direction and the X-direction is appropriately referred to as a Y-direction. Further, the side of the subject viewed from the lens body 11 may be referred to as the front side, and the opposite side (the image sensor 12 side) may be referred to as the rear side. The front side corresponds to the +Z side, and the rear side corresponds to the -Z side.

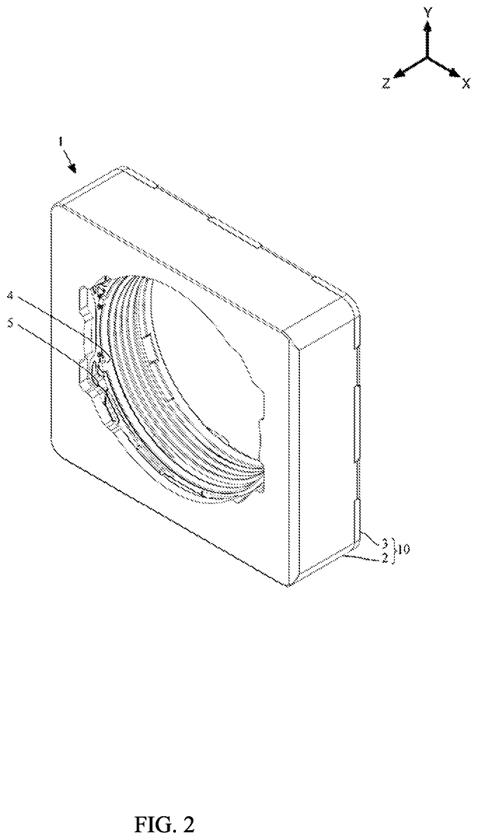

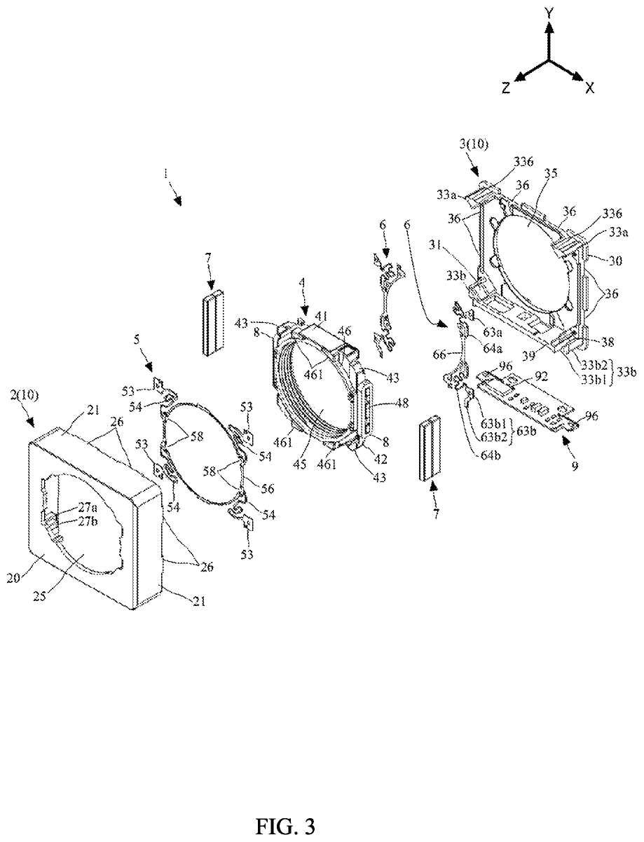

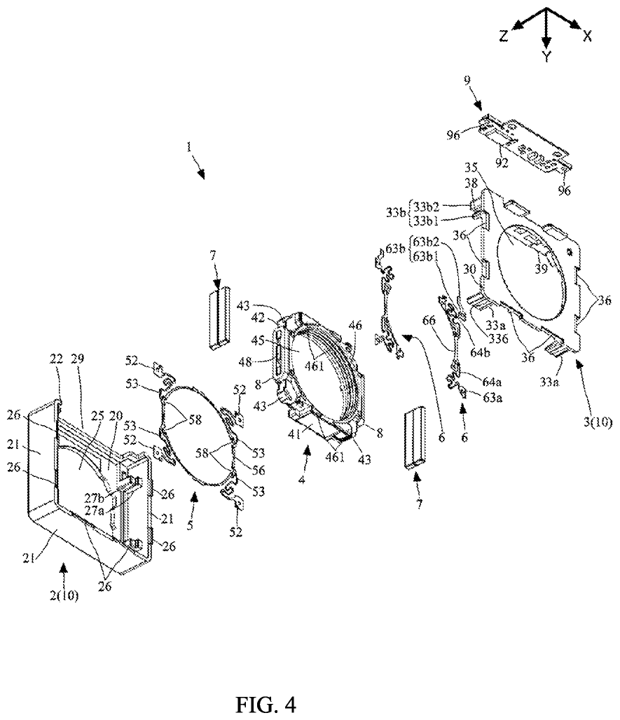

As shown in FIG. 2, FIG. 3 and FIG. 4, the optical member driving device 1 includes a carrier 4, a front side spring 5, two rear side springs 6, two magnets 7, two coils 8, and a FPC (Flexible printed circuits) 9 accommodated in a housing 10 obtained by combining a base 3 and a case 2. Of these portions, the housing 10, the magnets 7, and the FPC9 form a fixed portion, and the carrier 4 and the coils 8 form a movable portion moving relative to the fixed portion.

The details of the configuration of each portion will be described below. The case 2 includes a quadrangular front plate 20, a side plate 22 extending from the −Y side edge of the front plate 20 to the −Z side, and three side plates 21 extending from the other three edges to the −Z side. The side plate 22 on the −Y side of the case 2 has a concave portion 29 notched on the +Z side. Convex portions 26 are provided at the end edge of the side plate 21 on the −Z side. A through hole 25 is bored in the center of the front plate 20. Positioning protrusions of the front side spring 5 are provided at four corners of the rear surface of the front plate 20 of the case 2. Two pairs of convex pieces 27a and 27b separated in the Y-direction are provided on the inner side of the side plate 21 on the +X side and the inner side the side plate 21 on the −X side of the case 2, respectively. A magnet 7 is accommodated and fixed between each pair of the convex pieces 27a on the side plate 21. A coil 8 is accommodated with a gap between each pair of the convex pieces 27b on the side away from the side plate 21.

The base 3 includes: a quadrangular rear plate 30 corresponding to the quadrangle of the front plate 20; two column portions 33a rising from two corners on the +Y side of the rear plate 30 toward the +Z side; two column portions 33b rising from two corners on the -Y side of the rear plate 30 toward the +Z side; and a side plate 39 rising from an end edge of the rear plate 30 on the −Y side toward the +Z side. The side plate 39 is provided corresponding to the shape of the concave portion 29. A through hole 35 is bored in the center of the rear plate 30. Concave portions 36 recessed toward the side of the through hole 35 are provided at positions corresponding to the convex portions 26 of the case 2 at the end edge of the rear plate 30.

Of the column portions 33a and 33b at the four corners of the rear plate 30, the two column portions 33b on the −Y side are divided into an inner column piece 33b1 on the side of the through hole 35 and an outer column piece 33b2 on the side of the vertex of the corner. A gap 38 is provided between the inner column piece 33b1 and the outer column piece 33b2. Positioning protrusions of the rear side spring 6 are provided at positions slightly separated on a predetermined side of each of the column portions 33a and 33b at the four corners of the rear plate 30. A groove 336 is formed in the side surface on the +Y side of the column portion 33a. A plurality of rectangular holes are bored in the side plate 39.

The column portions 33a and 33b have opposing surfaces 31 on the inner peripheral side. The opposing surfaces 31 are opposed to the corner surfaces 43 of the carrier 4 to be described later. The opposing surfaces 31 are plane surfaces formed on the front halves of the column portions 33a and 33b, and are provided at 90-degree intervals facing the center of the through holes 35.

The FPC9 has a plate shape in which four corners of a rectangle are cut off. A plurality of components such as Hall elements 92 or lands 96 are provided on the surface of the FPC9 on the +Y side. A plurality of terminals (not shown) are provided on the surface of the FPC9 on the −Y side. The FPC9 is fixed to the side plate 39 in such a manner that the components on the surface on the +Y side thereof are accommodated in the rectangular holes of the side plate 39 of the base 3.

An adhesive is applied to the concave portions 36 and grooves 336 of the base 3, and the base 3 and the case 2 are joined by the adhesive. The convex portions 26 of the case 2 are fitted into the concave portions 36 of the base 3. The portion of the FPC9 on the +Z side is fitted into the concave portion 29 of the side plate 22 of the case 2, and the surface of the FPC9 on the −Y side is exposed to the outside of the case 2. Terminals of the FPC9 are connected to the substrate on which the image sensor 12 is mounted.

The carrier 4 is provided with a through hole 45 for attaching the lens body 11 as an optical member, and has a rectangular outer shape when viewed from the Z direction. The carrier 4 has two pairs of side surfaces 41 and side surfaces 42 facing each other in the Y-direction and the X-direction, and corner surfaces 43 chamfered at four corners. A convex portion 48 protruding outward in the X-direction is provided on the side surface 42. A coil 8 is wound around the convex portion 48. The coil 8 together with the magnet 7 generates the driving force of the movable portion.

The corner surfaces 43 are regulated by the side surfaces 41 and the side surfaces 42 in the circumferential direction, and regulated by the recess portions 431 described later on the front side and on the rear side. The corner surfaces 43 are provided at 90-degree intervals toward the side opposite to the center of the through hole 35. The corner surface 43 and the opposing surface 31 have approximately the same dimension in the Z direction thereof, but the opposing surface 31 is larger in the circumferential direction thereof, and they face each other in parallel.

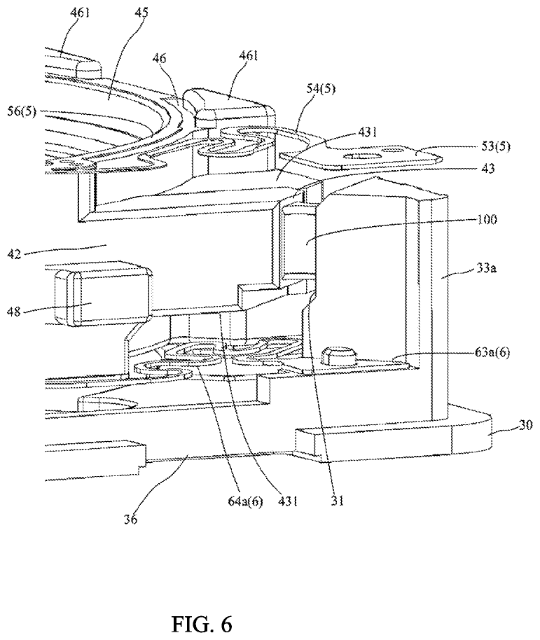

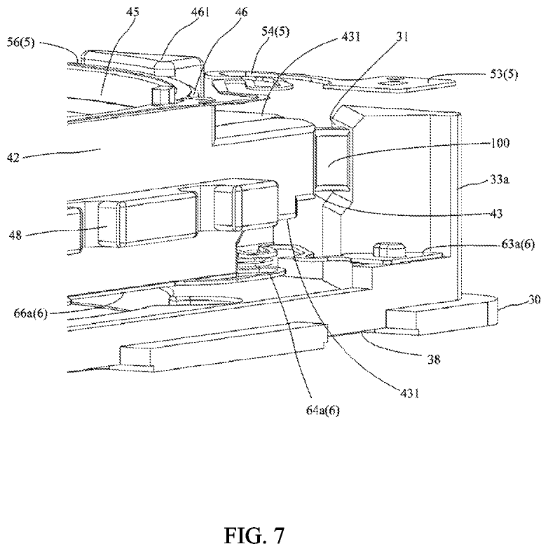

As shown in FIG. 6 and FIG. 7, the corner portions of the peripheral edge portion 46 of the through hole 45 on the +Z side and the −Z side are recessed toward the −Z side and the +Z side, respectively, as recess portions 431. By allowing an arm portion 54 of a front side spring 5 and arm portions 64a, 64b of rear side springs 6 described later to pass therethrough, the recess portions 431 act as escapes for the arm portion 54 and the arm portions 64a, 64b when the carrier 4 moves in the optical axis direction. Further, the dimensions of the corner surfaces 43 in the Z direction are regulated. Four convex portions 461 protruding toward the +Z side and the −Z side are formed on the front surface of the peripheral edge portion 46 on the +Z side and the rear surface of the peripheral edge portion 46 on the −Z side, respectively. Each of the convex portions 461 on the +Z side and the −Z side has a shape in which the hypotenuse of a right triangle is rounded inward in accordance with the peripheral edge portion 46. The convex portion 461 acts as a stopper in the optical axis direction of the carrier 4. Further, positioning protrusions of the front side spring 5 and the rear side springs 6 are provided on the front surface of the peripheral edge portion 46 on the +Z side and the rear surface of the peripheral edge portion 46 on the −Z side.

The front side spring 5 has one inner portion 56, four outer portions 53, and four arm portions 54 interposed between them. The inner portion 56 is provided with a bent portion 58 bent in a U-shape on the outer side. The outer portion 53 is formed in a rectangular shape. The outer portion 53 is bored with a positioning hole. The arm portion 54 has a zigzag shape. The arm portion 54 is connected to the inner portion 56 and the outer portion 53.

The inner portion 56 of the front side spring 5 is fixed to the peripheral edge portion 46 on the +Z side by fitting the positioning protrusion of the peripheral edge portion 46 on the +Z side of the carrier 4 into the bent portion 58 of the inner portion 56. The outer portion 53 of the front side spring 5 is fixed to the front plate 20 by fitting the positioning protrusion of the front plate 20 of the case 2 into the positioning hole of the outer portion 53.

The two rear side springs 6 are separated from each other on the +X side and the −X side to form a quadrangle as a whole. The two rear side springs 6 are electrically insulated from each other. Each of the two rear side springs 6 includes one inner portion 66, two outer portions 63a and 63b, an arm portion 64a interposed between the inner portion 66 and the outer portion 63a, and an arm portion 64b interposed between the inner portion 66 and the outer portion 63b.

The inner portion 66 is provided along the peripheral edge portion 46 of the carrier 4 and is bored with a positioning hole. In addition, it has an electrical connection portion electrically connected to the coil 8.

The outer portion 63a is located on the +Y side, and has a shape such that one apex angle of a triangle is cut. The outer portion 63b is located on the −Y side, and has an outer portion piece 63b1 and an extension piece 63b2. The outer portion 63a has a pentagonal shape. Positioning holes are bored in the outer portion 63a and the outer portion piece 63b1.

The extension piece 63b2 is fitted into the gap 38 of the base 3, extends from the base end connected to the outer portion piece 63b1 to the −Y side along the gap 38, and is connected to the land 96 of the FPC9.

The arm portions 64a and 64b have a zigzag shape. The arm portion 64a is connected to the inner portion 66 and the outer portion 63a, and the arm portion 64b is connected to the inner portion 66 and the outer portion 63b.

The inner portion 66 of the rear side spring 6 is fixed to the peripheral edge portion 46 on the −Z side by fitting the positioning protrusion of the peripheral edge portion 46 on the −Z side of the carrier 4 into the positioning hole of the inner portion 66. The outer portion 63 of the rear side spring 6 is fixed to the rear plate 30 by fitting the positioning protrusion of the rear plate 30 of the base 3 into the positioning hole of the outer portion 63a. The extension piece 63b2 is fitted into the gap 38.

The two coils 8 are formed by one coil wire, respectively, and both ends are electrically connected to the electrical connection portions of the rear side spring 6, respectively. The tip ends of the two extension pieces 63b2 of the rear side spring 6 are electrically connected to the lands 96 of the FPC9, respectively. Thereby, an electric current path of the external power source→the terminal of the FPC9→the land 96 of the FPC9 on the +X side→the rear side spring 6 on the +X side→the coil 8 on the +X side→the coil 8 on the −X side→the rear side spring 6 on the −X side→the land 96 of the FPC9 on the −X side→the terminal of the FPC9→the external power source is formed, and electric current is supplied to the coil 8.

As shown in FIG. 6 and FIG. 7, the corner surfaces 43 of the carrier 4 and the opposing surfaces 31 of the column portions 33a and 33b facing the corner surfaces 43 confront with each other in parallel, and viscoelastic resin 100 is provided between the corner surfaces 43 and the opposing surfaces 31. The viscoelastic resin 100 is a so-called damper gel. With the damper gel, vibration generated in the carrier 4 supported by the housing 10 via the front side spring 5 and the rear side spring 6 is quickly converged.

The above is the details of the configuration of the present embodiment. The optical member driving device 1 according to the present embodiment includes: a carrier 4 provided with a through hole 45 for mounting an optical member and having a rectangular outer shape; a housing 10 having a front plate 20 and a rear plate 30 opposite each other with the carrier 4 sandwiched therebetween, and a plurality of column portions 33a and 33b rising from the rear plate 30 toward the front plate 20; and a front side spring 5 and a rear side spring 6 arranged between the carrier 4 and the housing 10. Chamfered corner surfaces 43 are provided at four corners of the carrier 4, and viscoelastic resin 100 is provided between the corner surfaces 43 and the opposing surfaces 31 of the column portions 33a and 33b facing the corner surfaces 43. Vibration suppression effect is exhibited by the viscoelastic resin 100 between the corner surfaces 43 and the opposing surfaces 31. Further, since the shape of the carrier 4 is obtained by chamfering the four corners of the rectangle only, the carrier 4 is relatively easily manufactured. Therefore, it is possible to provide an optical member driving device 1, a camera device 15 and an electronic apparatus, which can exhibit stable vibration suppression effect and are easily manufactured.

It is to be noted that at least one of the corner surfaces 43 and the opposing surfaces 31 may be a curved surface instead of a plane surface. In addition, the surface may be rough. It is not necessary to provide the viscoelastic resin 100 all between each of the corner surfaces 43 and the opposing surfaces 31, and may be provided so as to obtain an appropriate vibration suppression effect. Further, the size of the corner surfaces 43 and the opposing surfaces 31 and the distance therebetween may be appropriately designed.

What is claimed is:

1. An optical member driving device comprising:
a carrier provided with a through hole for mounting an optical member and comprising a rectangular outer shape;
a housing comprising two opposite plates sandwiching the carrier and a plurality of column portions rising from one plate of the two plates toward the other plate of the two plates; and
springs arranged between the carrier and the housing,
wherein chamfered corner surfaces are provided at four corners of the carrier, and viscoelastic resin is provided between the corner surfaces and opposing surfaces of the column portions facing the corner surfaces.

2. The optical member driving device according to claim 1, wherein the carrier comprises two pairs of opposite side surfaces to form a rectangular outer shape, and the corner surfaces are regulated by one pair of the side surfaces and the other pair of the side surfaces.

3. The optical member driving device according to claim 1, wherein the carrier comprises recess portions recessed at the four corners of peripheral edge portion of the through hole toward an opposite side of the plates, and the corner surfaces are regulated by the recess portions.

4. The optical member driving device according to claim 3, wherein the springs are fixed to the peripheral edge portion and extend to the housing through the recess portions.

5. The optical member driving device according to claim 1, wherein the housing is a combination of a base comprising one plate and a cover comprising the other plate, and
the plurality of column portions rise from four corners of the plate comprised in the base toward four corners of the plate comprised in the cover.

6. A camera device comprising the optical member driving device according to claim 1.

7. An electronic apparatus comprising the camera device according to claim 6.
